(19) United States
(12) Patent Application Publication
(10) Pub. No.: US 2002/0135132 A1
(43) Pub. Date: Sep. 26, 2002

(54) Mechanical seal

(76) Inventors: Walter Telewiak, Lunenburg (CA); Ronald S. Warner, Long Sault (CA)

Correspondence Address: Gerald A. Gowan, 627 Lyons Lane,Suite 204, Oakville, ON, L6J 5Z7, CA

(21) Appl. No.: 09/730,386

(22) Filed: Dec. 6, 2000

(30) Foreign Application Priority Data
Dec. 9, 1999 (CA) 2292044

(51) Int. Cl. F16J 15/34

(52) U.S. Cl. 277/358

(57) ABSTRACT

A seal assembly is provided for use to seal the drive shaft entry opening on the stationary end plate of a bead mill, wherein the stationary and rotary faces of a mechanical seal are preferably held in operative contact by a bellows which acts as a spring biasing means. Use of the bellows inside of the bead mill allows the rotary and stationary faces of the mechanical seal to remain in constant contact, and thus acts to prevent loss of grinding material and/or the slurry to be ground through either the mechanical seal surface, or the spring biasing means. An improved bead mill sealing structure is obtained.

### FIELD OF THE INVENTION

This invention relates to a mechanical seal for a pump, or other such device, and in particular to a mechanical seal which can be used in a ball or bead mill apparatus. Further, the present invention relates to an internal mechanical seal for a ball or bead mill wherein liquid exits the ball or bead mill through and/or around the mechanical seal.

### BACKGROUND OF THE INVENTION

Ball or bead mills are commonly used in the paint and other industrial areas for the dispersion of pigments and the like into a liquid dispersant. In a typical ball or bead mill (hereinafter merely referred to as a bead mill), a charge of pigment and dispersant is mixed by the agitation or tumbling action of a collection of ceramic, steel or other type of beads or balls, which act as a grinding material. In practise, these beads or balls can vary in size from the millimeter range to the centimeter range. Also, the hardness of the beads or balls (hereinafter referred to as the “grinding media”) can vary depending on the hardness of the pigment or other material (hereinafter generally referred to as the “dispersed material”). The grinding media is usually harder than the dispersed material in order to effectively grind the dispersed material. During the bead or ball milling operation, the dispersed material is essentially “ground” to a finer particle size to, for example, make the dispersed material less likely to settle out of the dispersant. “Grinding” of the dispersed material may involve crushing of individual material particles between the particles of the grinding media, or can include the break-up of material agglomerates into smaller particles.

Various bead mill designs have been used over the years and can range from small laboratory scale models with a fluid capacity of less than 1 liter, to larger devices which can hold thousands of liters. Further, bead mills can be designed to operate on batch processes or on continuous feed processes.

In a typical continuous feed processes, the dispersed material is combined with the dispersant to form an slurry, which slurry is subsequently fed into one end of the bead mill. The slurry then passes from one end of the mill to the other. As it passes through the mill, the grinding media “grinds” the dispersed material to a desired particle size at which time, the ground dispersed material and dispersant pass through a dispersed material sieve (or screen) and exits the bead mill. The sieve acts to prevent material exiting the bead mill which has a larger than desired dispersed material particle size, and also acts to prevent the loss of grinding material.

Generally, the bead mill has a hollow cylindrical housing with two end plates. A central drive shaft enters one end of the hollow cylinder through one of the end plates. The drive shaft is connected to an external motor which acts to rotate the drive shaft inside of the stationary bead mill housing. By rotation of the shaft, various plates connected to the shaft, and internal to the bead mill, move in a rotary fashion and act to constantly agitate the grinding media. As the grinding media is agitated, it grinds the dispersed material. Commonly, the drive shaft extends into the bead mill but terminates within the bead mill. Accordingly, common continuous feed bead mills have a drive shaft extending through one end plate of the mill (hereinafter the “drive shaft plate end”, and a solid plate at the opposite end of the bead mill (hereinafter the “solid plate end”).

One example of a continuous feed bead mill is available from the Premier Mill Corporation under the trade mark of“Supermill”.

In operation, the manufacturer can design the bead mill so that the slurry of dispersant and dispersing material enters the mill at either the drive shaft plate end or the solid plate end, and moves through the mill to the opposite end plate.

In one commercially available bead mill, the slurry is fed from the drive shaft plate end and exits at the solid plate end. A fixed, non-moveable, sieve is located at the outlet of the bead mill to classify the milled product. A seal is located where the drive shaft enters the bead mill through the drive shaft end plate in order to prevent loss of material at the drive shaft opening. This seal can be relatively simple in design since no liquid is expected or desired to exit the bead mill at this end of the mill.

In other commercially available bead mills, the slurry is fed from the solid plate end of the mill and passes through the mill to exit at the drive shaft plate end. As a feature of this particular brand of bead mill, the ground product passes through a circular screen which is mounted on, and rotates with, the drive shaft. An “O-ring” seal of a flexible material is provided at one end of the screen assembly to prevent the slurry from by-passing the screen. Once past the screen the ground material passes through a chamber coaxial with the shaft to exit the bead mill through an annular opening in the drive shaft plate end which extends around the drive shaft. Once through the screen and outside of the grinding area of the bead mill, the ground material enters an external chamber with an outlet for the finished product to exit the bead mill. The finished product may be passed through a further screen or sieve to again control the particle size of the dispersed material. The seal between the rotating drive shaft and the stationary external chamber wall is a conventional seal assembly and encounters only product that has passed through the screen.

However, a common feature of this design is that the second end of the rotating screen assembly is sealed with a second seal assembly (hereinafter sometimes referred to as the “inner seal”) to the stationary drive shaft end plate in order to eliminate dispersed material, slurry, or grinding media from by-passing the screen.

Conventionally this inner seal has been provided by a set of “wear rings” comprised of a closely fit, matched set of rings. One ring (herein termed the “rotating ring”) is moving with the rotation of the drive shaft, and moves in close relationship with the matching, stationary ring which is fixed in place to the drive shaft end plate. The “gap” between the rotating ring and the stationary ring is small enough to prevent loss of oversized dispersed material, or grinding media through this second, inner seal.

In most common applications, this prior art inner seal arrangement can provide an effective, long lasting seal. However, under some circumstances this inner seal can prove to be ineffective. For example, grinding of a relatively hard dispersed material requires the use of harder grinding materials. Also, as a general rule, grinding of a dispersed material to a fine particle size requires smaller dispersing media. Thus, in operations where a hard dispersed material is to be ground to a fine particle size, a small, hard grinding material is often used. During the normal course of operation, some of the grinding media will chip or break into smaller pieces. These smaller pieces can be small enough to enter the gap between the rotating ring and the stationary ring of the wear rings of the inner seal. If the dispersing media is sufficiently hard, it can score, gouge or otherwise damage the wear rings and thus enlarge the gap between the rings. In a continuous bead mill, the constant rotation of the drive shaft can quickly lead to a rapid failure of the wear ring assembly which failure necessitates the replacement of the wear ring assembly.

Normally the wear rings are made of a hard, finely tooled material and are therefore, expensive to purchase. Also, the bead mill must be taken out of service and disassembled for replacement of the wear rings. While out of service, the lost production from the mill increases the expense of wear ring replacement.

There are numerous arrangements for sealing devices including “O-rings”, wear rings, and the like. A preferred seal, however, is a mechanical seal which type of seal generally provides a superior sealing arrangement. A conventional mechanical seal comprises: i) a “floating” component which is mounted axially and moves around a rotary shaft of, for example, a bead mill, and ii) a “static” component which is fixed, typically by being secured to a housing. The floating component typically has a flat annular end face, i.e. its seal face, directed towards a complementary seal face of the static component. The floating component is urged towards the static component to close the seal faces together to form a sliding face seal, usually by means of one or more springs. In use, one of the floating or static components is rotated and therefore, this component is referred to as the rotary component. The other of the floating and static components does not rotate and is referred to as the stationary component.

The rotary and stationary components may also be referred to as the rotational and non-rotational components (or portions) of a seal, respectively.

Because of the spring biasing of the seal faces together, there is no gap for damaging particles to enter. Accordingly, the use of a mechanical seal as the inner seal would be desirable. However, in practise, in bead mill applications, it has heretofore proven difficult to provide a cost effective mechanical seal which would easily provide the necessary properties.

### SUMMARY OF THE INVENTION

Accordingly, it is a principal object of the present invention to provide a mechanical seal to act as an inner seal on a bead mill of the type described hereinabove.

It is a further object to provide a bead mill having a product discharge at the drive shaft plate, which utilizes a mechanical seal as an inner seal.

The foregoing objects are attained by providing a mechanical seal which is connected to a screen assembly which is attached to a shaft sleeve on the drive shaft of a bead mill.

Accordingly, the present invention in one aspect provides a mechanical seal for use to seal the drive shaft entry opening on the stationary end plate of a bed mill, comprising:

i) a shaft sleeve adapted to closely fit over a drive shaft and rotate with said drive shaft, which shaft sleeve will pass through an opening in the end plate of said bead mill to provide an outer sleeve end outside of said bead mill and an inner sleeve end inside of the bead mill, and will define a first gap between said end plate and said shaft sleeve;

ii) a screen assembly attached to said inner sleeve end, which screen assembly contains a screen and rotates with said shaft sleeve, and which screen assembly essentially defines a first space between said screen assembly and said shaft sleeve, so that product can pass through said screen into said first space and then from said first space through said first gap; and

iii) a mechanical seal having a rotary and a stationary face wherein said stationary face is adapted to be fixed to said end plate, and said rotary face is attached to said screen assembly, and said stationary face or said rotary face are operatively connected and are biased towards each other by a spring biasing means, and wherein said spring biasing means is essentially sealed so as to prevent liquid from moving into said first space through said spring biasing means.

### DETAILED DESCRIPTION OF THE INVENTION

The term “drive shaft” is preferably used to describe a rotating drive shaft. The drive shaft is preferably driven by an electric motor, but other drive means can be used. The motor is preferably located outside of the bead mill. The drive shaft is preferably at least partially “keyed” so as to have a flat spot on a general circular shaft (in cross section). By having corresponding, mated flat areas on any devices mounted on the drive shaft, the rotation of the drive shaft will cause rotation of the various devices. This can include the sleeve shaft although a variety of methods can be used to connect the drive shaft to the shaft seal or other devices mounted on the drive shaft.

As previously stated, the bead mill is preferably a hollow cylindrical vessel having a two end plates attached to the cylinder ends. One end plate has an opening through which the drive shaft can enter the bead mill. The drive shaft preferably extends into the bead mill but terminates short of the second end plate, and thus terminates within the bead mill.

The shaft sleeve preferably has an inner diameter which is essentially the same as the outer diameter of the drive shaft. Further, it is preferred that the shaft sleeve be provided with sleeve sealing means to seal the inner and outer ends of the shaft sleeve to the drive shaft. These sleeve sealing means are preferably one or more “O-rings” located at, or near the end of the shaft sleeve. In this fashion, liquid is prevented from entering, or moving along, the space between the shaft sleeve and the drive shaft.

In a typical configuration of a bead mill, the shaft sleeve slides over the drive shaft. A number of drive plates and spacers are also inserted over the drive shaft and the entire assembly is held tight on the drive shaft by bolting a plate to the terminal end of the drive shaft. This bolted plate exerts pressure on the drive plates, spacers and the shaft sleeve. The other, outer end of the shaft sleeve is preferably held tight against a larger diameter area of the drive shaft. The location of this change in drive shaft diameter can vary, but is preferably normally outside of the bead mill housing in order to provide an essentially constant diameter drive shaft within the bead mill.

However, variations of this design are possible. The primary function of the shaft sleeve is to provide a location for mounting of the screen assembly while also allowing the spacers and drive plates to be tightened onto the shaft. In one variation, however, the shaft sleeve could be an integral part of the drive shaft, or in another variation, the drive shaft could change diameter inside of the bead mill housing, and thus, the shaft seal would not need to be very long. In a further embodiment, the shaft sleeve could be an integral part of the screen assembly.

For the bead mill of primary interest in the present invention, the shaft sleeve preferably extends though the end plate of the bead mill. Further, for this type of bead mill, the hole in the end plate is larger than the shaft sleeve, thus leaving a gap between the end plate and the shaft sleeve through which the finished product can exit the bead mill.

In the preferred embodiment of the present invention, the screen assembly is bolted to the inner end of the shaft sleeve and extends radially away from the shaft sleeve. A product screen with the desired particle size openings is located on the screen assembly and is generally coaxial with the drive shaft. The screen acts to prevent excessively large particles, or the grinding media, from exiting the bead mill. The screen assembly thus defines an annular open space between the shaft sleeve and the screen assembly.

The stationary ring of the mechanical seal is attached to the end plate and is directed towards the screen assembly. The rotating ring of the mechanical seal is attached to the screen assembly and is directed towards the stationary ring. A spring-biasing means is used to maintain the stationary ring and the rotating ring in operative contact. Preferably, the spring biasing means is located on said screen assembly and acts to move said rotary face into contact with said stationary face.

The spring biasing means is preferably sealed so that essentially none of the finished, or slurried product can pass through. A preferred spring biasing means is provided by a compressed bellows arrangement. By compressing the bellows, the bellows act to press the rotary face of the rotating ring into the stationary face of the stationary ring, thus creating the mechanical seal. The bellows is also preferably a solid device which can be attached to the screen assembly and to the rotating ring, in order to create a spring biasing means through which the finished or slurried product cannot pass.

In a preferred embodiment, the bellows can be covered in a flexible material in order to prevent grinding media, or dispersed material from getting into the gaps between the “vanes” of the bellows.

The materials of construction of the mechanical seal or the bead mill can vary depending on the type of materials to be used as grinding media, dispersant, or dispersing material, or can vary depending on the temperature or pressure under which the bead mill is used. Selection of these materials are standard in the industry.

The temperature and pressure in the bead mill can be controlled by, for example, having an external cooling or heating jacket affixed to the bead mill housing, or by controlling the pressure at which the slurry is pumped into the bead mill.

The selection of grinding material is also an established area of this industry. Generally, however, the desired particle size and hardness of the dispersed material will dictate the grinding material to be used. Further, the size and shape of the screen used on the screen assembly will also be dictated by the desired particle size and by the size of the grinding media to be used.

As an example of suitable materials, the mechanical seal and bead mill of the present invention can be used to prepare a 50% aqueous dispersion of anthraquinone in water. Anthraquinone powder with a particle size of about 150 microns is slurried in water and fed to a steel, continuous bead mill with a total volume of about 30 liters. The grinding media is a zirconium silicate bead having a diameter of 0.6 to 0.8 mm. The steel drive shaft of the bead mill rotates at a speed of about 1000 r.p.m.. A plurality of steel, circular drive plates are attached to the drive shaft and act to agitate the grinding media. The steel screen assembly includes a steel screen having openings of about 10 thousands of an inch, in order to produce a finished anthraquinone dispersion with a particle size of about 5 microns. The material of the sliding surfaces of the mechanical seal, in this embodiment, are made of tungsten carbide.

The present invention is also directed to a bead mill utilizing the mechanical seal of the present invention. Accordingly, in a further aspect, the present invention also provides a bead mill which contains a mechanical seal as described herein with respect to the present invention.

In a yet still further aspect, the present invention also provides a method of bead milling a slurried product. Accordingly, the present invention also provides a method of bead milling a slurried product, which method comprises passing said slurried product through a bead mill of the type herein described with respect to the present invention.

Further, although reference is made herein to bead mills, it should be understood that mechanical seals of the invention have use in other mechanical seal applications

Other features of the present invention, as well as other objects and advantages attendant thereto, are set forth in the following description and the accompanying drawings in which like reference numerals depict like elements.

### BRIEF DESCRIPTION OF THE DRAWINGS

A preferred embodiment of the mechanical seal of the present invention will now be described, by way of example only, and with reference to the following drawings wherein:

FIG. 1 is a cross-sectional view of a bead mill of the type of primary interest in the application of the present invention, which bead mill utilizes a “wear ring” assembly according to the prior art;

FIG. 2 is a cross-sectional view of the wear ring and end plate area of the bead mill of FIG. 1;

FIG. 3 is a cross-sectional view of the mechanical seal and end plate area of a bead mill according to the present invention;

FIG. 4 is a cross-sectional view of a modified version of the mechanical seal of FIG. 3; and

FIG. 5 is a perspective, cutaway drawing of a bead mill with the mechanical seal in place.

### DETAILED DESCRIPTION OF A PREFERRED EMBODIMENT

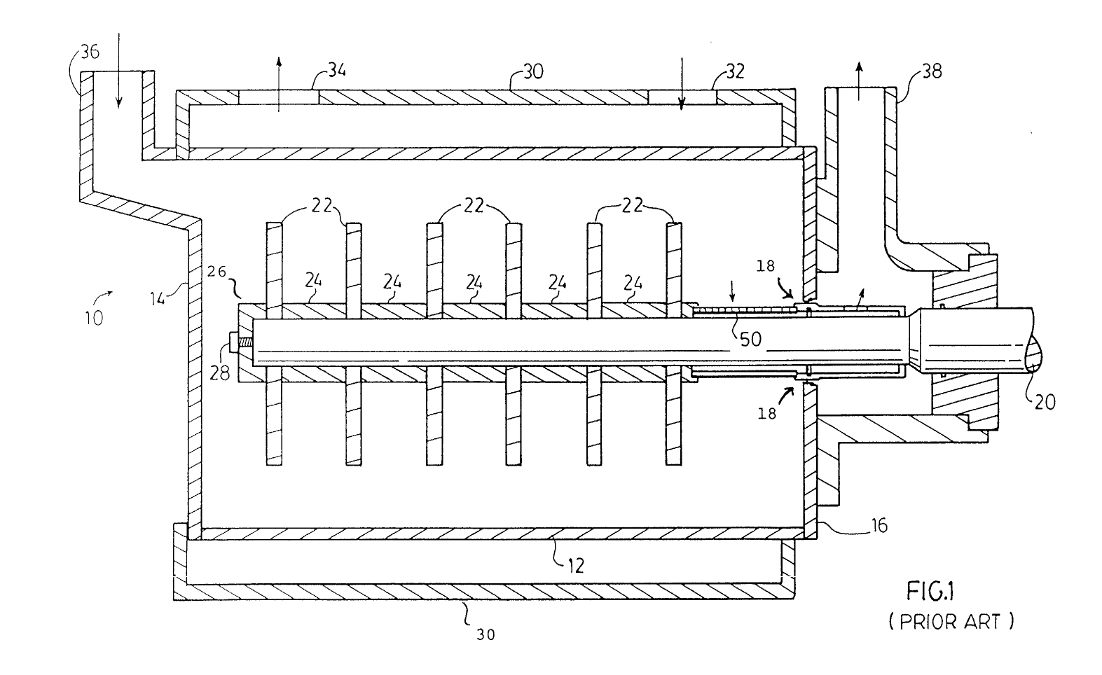

In FIG. 1 a bead mill 10 is shown comprised of a cylindrical housing 12 with and two end plates 14 and 16. End plate 16 has a circular opening 18 though which drive shaft 20 passes. Attached to drive shaft 20 are various drive plates 22 and spacers 24 which are held on shaft 20 by terminal bracket 26 and bolt 28. A water jacket 30 surrounds housing 12 and has a water inlet 32 and water outlet 34. Housing 12 also includes a slurry inlet 36 and a finished product outlet 38.

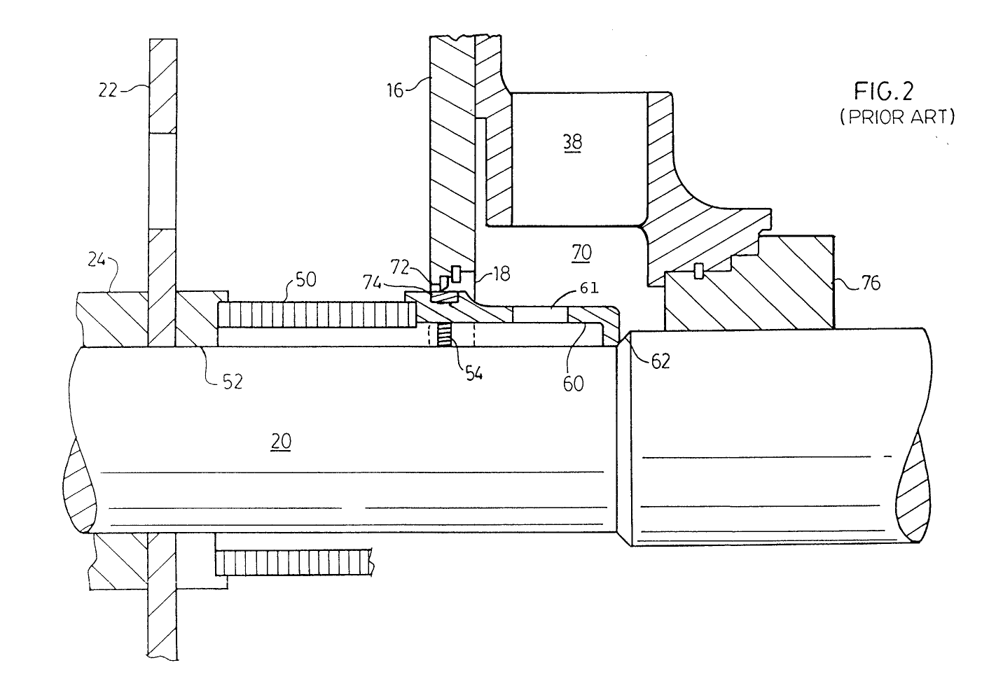

Product leaves housing 12 by passing though screen 50. The details of this area of the bead mill are best seen in FIG. 2

In FIG. 2, a portion of drive shaft 20 is shown together with a drive, plate 22, end plate 16, opening 18 and part of product outlet 38. Screen 50 is connected to drive shaft 20 by screen supports 52 and 54. A spacer sleeve 60 positions screen 50 and screen supports 52 and 54 on the drive shaft 20. Spacer sleeve 60 abuts a larger diameter section 62 in drive shaft 20. Holes in screen support 54 allow product to pass alongside drive shaft 20. Holes 61 in spacer plate 60 allow finished product to pass into external chamber 70, and then out of the bead mill through outlet 38. A mechanical seal 76 seals external chamber 70 to drive shaft 20.

A wear ring assembly is provided including a stationary ring 72, attached to end plate 16, and a rotating ring 74 attached to screen support 54.

In operation, water is fed into water jacket of bead mill assembly 10 through water inlet 32 and exits mill 10 through outlet 34. A slurry product is fed into mill 10 through inlet 36 and passes through mill 10 towards outlet 38. Arrows are shown in FIG. 1 to indicate water or slurry movements. The slurry is mixed with grinding media (not shown) in the mill and is agitated by the movement of drive plates 22. The agitation of the slurry and the media grinds the dispersed material to form the finished product. When the dispersed material has been ground to a small enough particle size, it will pass through screen 50, and travel alongside shaft 20, passing through the holes in screen support 54, and then entering external chamber 70 through holes 61 in spacer sleeve 60. From external chamber 70, finished product exits the mill through outlet 38.

Product is prevented from by-passing the screen 50 by use of wear rings 72 and 74 which prevent product from passing from the mill directly to external chamber 70 without going through screen 50. Stationary ring 72 is attached to end plate 16, while rotating ring 74 is attached to screen support 54.

Wear rings 72 and 74 can provide adequate sealing to prevent loss of material through gap 18 which has not gone through screen 50. However, if scored, gouged, or otherwise damaged, slurried product and grinding media can pass from the bead mill directly to external chamber 70 without passing through screen 50. This wear ring failure can lead to the loss of the grinding media, and to production of “off-spec” material.

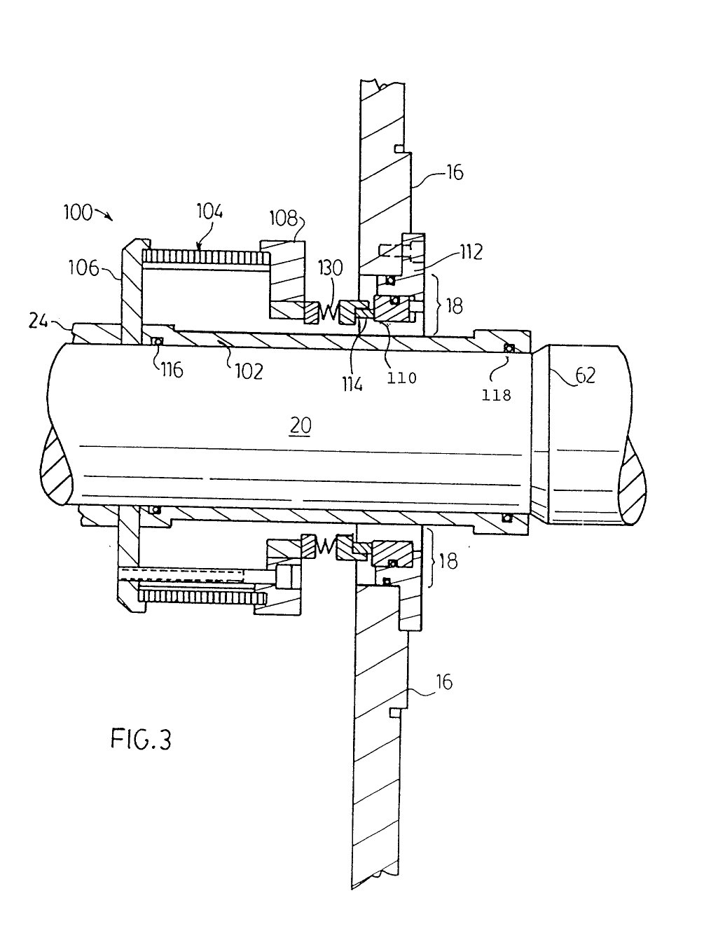

In FIG. 3, a mechanical seal arrangement for a bead mill of interest in the present invention is shown. FIG. 3 shows a drive shaft 20 inserted through gap 18 in end plate 16. Drive shaft 20 has a larger diameter drive shaft enlargement ring beginning at 62, and a portion of first spacer 24 is also shown. Also shown in FIG. 3 is a mechanical seal 100 according to the present invention. Mechanical seal 100 has a shaft sleeve 102 which is coaxial with drive shaft 20. Shaft sleeve 102 is sealed to drive shaft 20 through the use of two “O-rings” 116 and 118. Screen 104 is attached to screen supports 106 and 108. The stationary ring 110 of mechanical seal 100 is attached to end plate 16 through a stationary ring support assembly 112. Rotating ring 114 of mechanical seal 100 is attached to screen support 108 using bellows 130. All other features of the bead mill of FIG. 3 are the same as in the bead mill of FIG. 1 or 2.

In operation, finished product passes through screen 104, passes between shaft sleeve 102 and the rotating 114 and stationary rings 110 and exits the bead mill through gap 18. Once outside of the bead mill, the finished product can be removed in the same fashion as shown in FIG. 2.

Shaft sleeve 102 is closely fit to drive shaft 20, and is sealed using “O-rings” 116 and 118. Shaft sleeve 102 abuts drive shaft enlargement ring 62, and is held in place by the pressure from spacer 24. A screen support assembly 106 abuts shaft sleeve 102 and is also held in place by the pressure from spacer 24. Screen 104, support 106 and 108, bellows 130, stationary ring 110 and rotating ring 114 are all circular and extend around drive shaft 20.

Bellows 130 is attached to screen support 108 and is slightly compressed during assembly of the mechanical seal. Accordingly, bellows 130 exerts pressure on the rotating ring 114 of the mechanical seal. This pressure ensures that the face of rotating ring 114 is kept in constant contact with the face of stationary ring 110. In this fashion, a effective mechanical seal is established.

Further, since bellows 130 is a solid piece of steel, no liquid can by-pass the mechanical seal. Thus, the seal integrity is maintained.

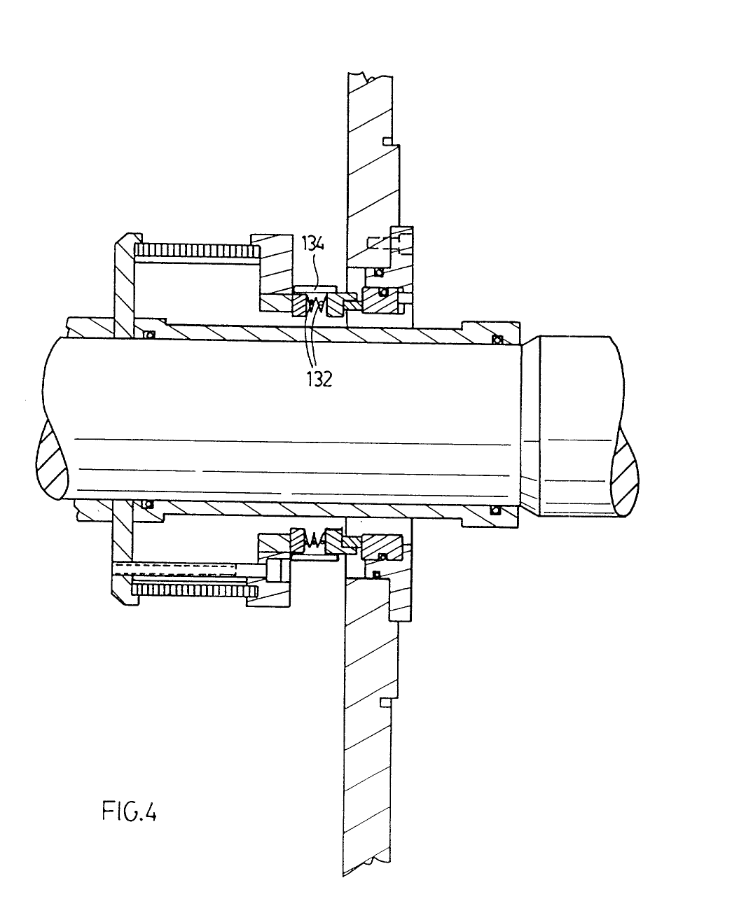

In a further preferred embodiment, shown in FIG. 4, the gaps between the “vanes” of the bellows are filled with a flexible material 132, such as a rubber band. These rubber bands are flexible enough to allow bellows 130 to expand or contract, as necessary, but also act to prevent any material (such as the grinding media) to enter the gaps between the vanes. Also, the entire bellows section is covered with a further flexible shield 134 in order to also assist in preventing materials from entering the gap between the vanes of bellows 130.

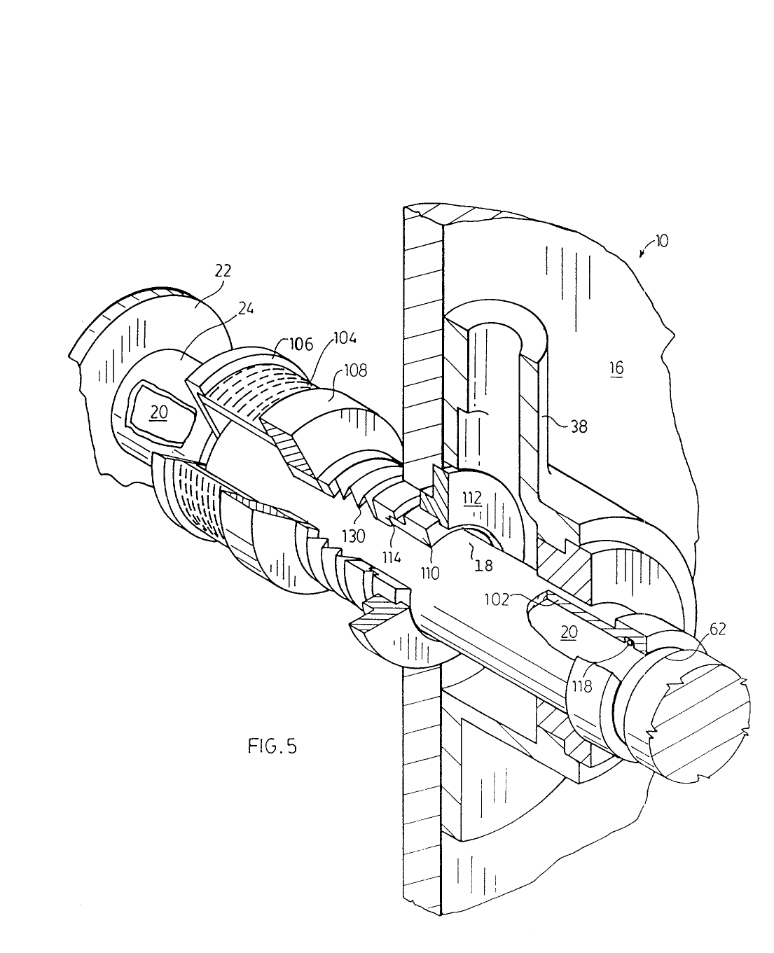

The features of the bead mill, and the mechanical seal described in FIGS. 3 and 4, are more clearly shown in FIG. 5.

Thus, it is apparent that there has been provided, in accordance with the present invention, a mechanical seal which fully satisfies the means, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

The embodiments of the invention in which an exclusive property or privilege is claimed are defined as follows:

1. A mechanical seal assembly for use in sealing a drive shaft entry opening on a stationary end plate of a bead mill, wherein said seal comprises:
i) a shaft sleeve adapted to closely fit over a drive shaft and rotate with said drive shaft, wherein said shaft sleeve passes through an opening in the end plate of said bead mill to provide an outer sleeve end outside of said bead mill and an inner sleeve end inside of the bead mill, and wherein said shaft sleeve defines a first gap between said end plate and said shaft sleeve;
ii) a screen assembly attached to said inner sleeve end, which screen assembly contains a screen, and rotates with said shaft sleeve, and which screen assembly essentially defines a first space between said screen assembly and said shaft sleeve, wherein product passes through said screen into said first space, and then from said first space through said first gap; and
iii) a mechanical seal having a rotary and a stationary face wherein said stationary face is adapted to be fixed to said end plate, and said rotary face is attached to said screen assembly, wherein said stationary face and said rotary face are operatively connected and are biased towards each other by a spring biasing means, and wherein said spring biasing means is essentially sealed so as to prevent liquid from moving into said first space through said spring biasing means.

2. A mechanical seal assembly as claimed in claim 1 wherein said shaft sleeve has an inner diameter which is essentially the same as the outer diameter of the drive shaft.

3. A mechanical seal assembly as claimed in claim 2 wherein said shaft sleeve comprises a sleeve sealing means to seal the inner and outer ends of the shaft sleeve to the drive shaft.

4. A mechanical seal assembly as claimed in claim 3 wherein said sleeve sealing means are one or more “O-rings”.

5. A mechanical seal assembly as claimed in claim 1 wherein said stationary ring of the mechanical seal is attached to the end plate and is directed towards the screen assembly, and said rotary ring of the mechanical seal is attached to the screen assembly and is directed towards the stationary ring

6. A mechanical seal assembly as claimed in claim 1 wherein said spring biasing means is located on said screen assembly and acts to move said rotary face into contact with said stationary face.

7. A mechanical seal assembly as claimed in claim 1 wherein said spring biasing means is sealed.

8. A mechanical seal assembly as claimed in claim 1 wherein said spring biasing means is a compressed bellows.

9. A mechanical seal assembly as claimed in claim 8 where said compressed bellows is attached to the screen assembly and to the rotating ring, in order to create a spring biasing means through which the finished or slurried product cannot pass.

10. A mechanical seal assembly as claimed in claim 8 wherein said bellows comprises a series of vanes, which vanes are covered by a flexible material in order to prevent grinding media or dispersed material from entering the gaps between the vanes of the bellows.

11. A mechanical seal assembly as claimed in claim 1 wherein said shaft sleeve is held tight against a larger diameter area of the drive shaft.

12. A mechanical seal assembly as claimed in claim 11 wherein said shaft sleeve is an integral part of the drive shaft.

13. A mechanical seal assembly as claimed in claim 1 wherein said shaft sleeve is an integral part of the screen assembly.

14. A mechanical seal assembly as claimed in claim 1 wherein said shaft sleeve extends though the end plate of the bead mill.

15. A bead mill comprising a hollow cylindrical vessel having a two end plates attached to the cylinder ends, a drive shaft which enters the bead mill through an opening in one end plate, and a mechanical seal assembly for sealing the drive shaft, wherein said mechanical seal assembly comprises:
i) a shaft sleeve adapted to closely fit over said drive shaft and rotate with said drive shaft, which shaft sleeve will pass through said opening in the end plate of said bead mill to provide an outer sleeve end outside of said bead mill and an inner sleeve end inside of the bead mill, and will define a first gap between said end plate and said shaft sleeve;
ii) a screen assembly attached to said inner sleeve end, which screen assembly contains a screen and rotates with said shaft sleeve, and which screen assembly essentially defines a first space between said screen assembly and said shaft sleeve, so that product can pass through said screen into said first space, and then from said first space through said first gap; and
iii) a mechanical seal having a rotary and a stationary face wherein said stationary face is adapted to be fixed to said end plate, and said rotary face is attached to said screen assembly, and said stationary face or said rotary face are operatively connected and are biased towards each other by a spring biasing means, and wherein said spring biasing means is essentially sealed so as to prevent liquid from moving into said first space through said spring biasing means.

16. A bead mill as claimed in claim 15 wherein the drive shaft extends into the bead mill but terminates short of the second end plate, and thus terminates within the bead mill.

17. A method of bead milling a slurried product, which method comprises passing said slurried product through a bead mill of the type as claimed in claim 15.

18. A method of producing a dispersion of anthraquinone in water comprising passing a slurry of anthraquinone powder in water through a bead as claimed in claim 15.
